(19) United States
(12) Patent Application Publication
(10) Pub. No.: US 2010/0176529 A1
(43) Pub. Date: Jul. 15, 2010

(54) Vehicle Foam Assemblies And Methods Of Creating Vehicle Interior Trim

(75) Inventors: Robert R. Chimelak, Warren, MI (US); Aaron S. Wisniewski, Plymouth, MI (US)

Correspondence Address: GIBSON & DERNIER LLP, 900 ROUTE 9 NORTH, SUITE 504, WOODBRIDGE, NJ, 07095, US

(73) Assignee: FAURECIA INTERIOR SYSTEMS U.S.A., INC., Auburn Hills, MI (US)

(21) Appl. No.: 12/353,880

(22) Filed: Jan. 14, 2009

(51) Int. Cl. B29C 67/20

(52) U.S. Cl. 264/46.4

(57) ABSTRACT

Vehicle foam assemblies and methods of creating vehicle interior trim are provided for placing one or more insert components onto and/or into a foam tool; laying a skin proximate to the one or more insert components; placing a substrate proximate to the skin; and introducing foam to form or re-form the skin against and/or around the one or more insert components.

### FIELD OF THE INVENTION

The present invention is directed to vehicle foam assemblies and methods of creating vehicle interior trim for forming or re-forming a skin against and/or around one or more insert components.

### BACKGROUND OF THE INVENTION

Currently, trim components, such as In-Mould-Grain (hereinafter referred to as “IMG”) components, decorative components, films, mold inserts, etc., are separate parts manufactured by complex processes which are then mechanically secured to a substrate. The trim components are typically employed in an interior of a vehicle (e.g., an instrument panel of a vehicle, door chassis or panel systems, etc.). Due to the complexity of the processes involved, creating the separate parts can lead to excess costs, especially when more than one tool is required for creating the components. Additionally, when combining the separate parts, such as a skin (also referred to as a “skin component”) with another trim component (e.g., a decorative component, film insert, etc.), current skin tools employ complex processes, which result in gaps between the combination of the skin and the other trim component(s). These gaps can result in low visual quality of the resulting vehicle trim.

The prior art tools used to manufacture the skin are also very costly, and must be manufactured to accept specific trim components. If various trim levels exist or are requested by the Original Equipment Manufacturer (hereinafter referred to as the “OEM”), the skin tools must be duplicated to accommodate the additional trim levels. The OEM would like to prevent such duplication of skin tools to avoid additional costs.

When dealing with IMG processes in particular, the OEM desires to create interior skins for a vehicle with a defined grain that repeats a high visual quality regardless of the skin properties, such as skin level complexity, grain depth, texture, other requested OEM features, etc. The OEM would like to offer various models, ranging from base models to premium models, with lower costs and less tooling associated with the production of the models. For example, base models may require one skin tool that does not need to accommodate an insert or decorative component while premium or upscale models would require a skin tool with a formed pocket to accept the interior trim or decorative component. As such, for a plurality of models, the OEM would require two or more skin tools, which leads to undesirable additional costs. Thus, for the OEM to upgrade models and/or to manufacture a variety of models, additional IMG tooling is required, which includes employing additional costly skin tools.

Providing opportunities for reducing costs associated with creating interior trim components and utilizing a more efficient and/or compact tool design are important for achieving lower manufacturing costs, upgrading trim levels without additional tooling, and reducing and/or eliminating visually unappealing gaps in the final product. Employing current skin tools with currently known complex processes results in inefficiencies, such as increased cost, inefficient use of space (e.g., creation of visually unappealing gaps), etc., during manufacture and/or operation.

Therefore, there is a need in the art for a reducing the cost and/or the number of skin tools required, and for providing efficient use of space (e.g., reducing and/or eliminating gaps), while creating vehicle trim(s).

### SUMMARY OF THE INVENTION

In accordance with one or more aspects of the present invention, vehicle foam assemblies and methods of creating vehicle interior trim are provided with a skin that is placed into and/or onto a foam tool to be formed and/or re-formed around at least one insert component. The vehicle interior trim is used for constructing a vehicle, such as on a vehicle substrate (e.g., for use on an instrument panel, a door chassis, etc.). Such a construction reduces costs typically associated with trim manufacturing, and such a construction utilizes compact tooling design (e.g., a foam tool is more compact and less costly than the traditional skin tools) and provides efficient use of space (e.g., because gaps are reduced and/or eliminated, less overall space is needed for completed interior trim).

In accordance with one or more embodiments of the present invention, a method of creating vehicle interior trim includes: placing one or more insert components into a foam tool; laying a skin over the one or more insert components; placing a substrate over the skin; and introducing foam to re-form the skin against and/or around the one or more insert components.

The foam may be inserted between the substrate and the skin to push the skin away from the substrate and towards the one or more insert components located within the foam tool. The foam may expand to push the skin away from the substrate and towards the one or more insert components. The expansion of the foam may create pressure and/or temperature conditions for pushing the skin towards the one or more insert components.

The one or more insert components may be adhesively coated such that the one or more insert components bond to the skin when the foam pushes the skin against and/or around the one or more insert components. The coating may be located on a surface of the one or more insert components facing the skin. The adhesive coating of the one or more insert components may be activated to bond the one or more insert components to the skin with at least one of: pressure and temperature. The one or more insert components may be at least one of: a decorative insert, a foil, and an insert molding film.

The skin may be negatively formed (e.g., via an In-Mould Graining process), or positively formed. The skin may be formed before re-formation. The skin may be negatively formed or positively formed before re-formation.

The one or more insert components may be arranged on and/or in the re-formed skin in at least one of: a subflush arrangement, a flush arrangement, and a proud arrangement. The one or more insert components may be held in position with at least one of: a locating feature and a vacuum.

A raised locating feature and/or the vacuum, disposed on the foam tool, may be employed to allow the skin to re-form against and/or around the one or more insert components, thereby creating the subflush arrangement. A depressed locating feature and/or the vacuum in communication with a surface of the foam tool on which the one or more insert components are disposed may be included, to allow the skin to re-form and create the proud arrangement.

The one or more insert components may bond with the skin at various depths to create one or more layer levels of the skin, wherein the foam tool allows the re-formation of the skin against and/or around the one or more insert components at the various depths. One or more locating features may be employed for creating the one or more layer levels.

The foam tool may include a cavity for disposing at least one of: the skin, the one or more insert components, and the substrate.

A combination of the skin and the one or more components may result in a vehicle interior trim.

In accordance with one or more further embodiments of the present invention, a method of creating vehicle interior trim includes: placing one or more insert components onto and/or into a foam tool; laying a skin proximate to the one or more insert components; placing a substrate proximate to the skin; and introducing foam to form the skin against and/or around the one or more insert components.

Foam may be inserted between the substrate and the skin to push the skin away from the substrate and towards the one or more insert components located within the foam tool. The foam may be injected under pressure and/or allowed to expand to push the skin away from the substrate. The foam may expand, thereby creating a pressure and/or temperature.

The skin may be negatively formed during formation; and/or positively formed during formation. The negative formation may be an In-Mould Graining process.

The one or more insert components may be arranged on and/or in the formed skin in at least one of: a subflush arrangement, a flush arrangement, and a proud arrangement. The one or more insert components may be held in position with at least one of: a locating feature and a vacuum.

A raised locating feature and/or the vacuum, disposed on the foam tool, may be employed to allow the skin to form against and/or around the one or more insert components, thereby creating the subflush arrangement. A depressed locating feature and/or the vacuum in communication with a surface of the foam tool on which the one or more insert components are disposed may be included, to allow the skin to form and create the proud arrangement. A locating feature and/or the vacuum, disposed on the foam tool, may be employed to allow the skin to form against and/or around the one or more insert components, such that a surface portion of the one or more insert components is substantially aligned with a surface of the skin, thereby creating the flush arrangement.

One or more layer levels may be created by placing the one or more insert components on and/or in the skin at various depths, wherein the foam tool allows the formation of the skin against and/or around the one or more insert components at the various depths.

The types of vehicles in which the present invention may be employed are numerous and include: automobiles, planes, trains, trucks, buses, boats, helicopters, submersible vehicles, spacecraft, etc.

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustrating the various aspects of the invention, wherein like numerals indicate like elements, there are shown in the drawings simplified forms that may be employed, it being understood, however, that the invention is not limited by or to the precise arrangements and instrumentalities shown, but rather only by the claims. The drawings may not be to scale, and the aspects of the drawings may not be to scale relative to each other. To assist those of ordinary skill in the relevant art in making and using the subject matter hereof, reference is made to the appended drawings and figures, wherein:

FIG. 1 is a flow diagram of a method of creating trim for use in a vehicle in accordance with at least one aspect of the present invention.

FIG. 2 is a front schematic view of a vehicle foam assembly including a foam tool for combining a skin and an insert component in accordance with at least one aspect of the present invention.

FIG. 3 is a front schematic view of the vehicle foam assembly of FIG. 2, including a foam tool for combining a skin and an insert component while inserting foam between a substrate and the skin in accordance with at least one aspect of the present invention.

FIG. 4a is a front schematic view of the vehicle foam assembly of FIG. 2, including a foam tool, for combining a skin and an insert component, which is inserting foam between a substrate and the skin to re-form the skin around the insert component in accordance with at least one aspect of the present invention.

FIG. 4b is a side schematic view of the created vehicle trim removed from the vehicle foam assembly of FIG. 4a in accordance with at least one aspect of the present invention.

FIG. 5a is a front schematic view of another embodiment of a vehicle foam assembly including a foam tool, for combining a skin and an insert component, employing a raised locating feature for providing a subflush arrangement of the insert component in the skin in accordance with at least one aspect of the present invention.

FIG. 5b is a side schematic view of the created vehicle trim removed from the vehicle foam assembly of FIG. 5a in accordance with at least one aspect of the present invention.

FIG. 6a is a front schematic view of a further embodiment of a vehicle foam assembly including a foam tool, for combining a skin and an insert component, employing a depressed locating feature for providing a proud insert arrangement of the insert component in the skin in accordance with at least one aspect of the present invention.

FIG. 6b is a side schematic view of the created vehicle trim removed from the vehicle foam assembly of FIG. 6a in accordance with at least one aspect of the present invention.

FIG. 7a is a front schematic view of yet a further embodiment of a vehicle foam assembly including a combination of raised and depressed locating features for providing more than one layer level in the skin in accordance with at least one aspect of the present invention.

FIG. 7b is a side schematic view of the created vehicle trim removed from the vehicle foam assembly of FIG. 7a in accordance with at least one aspect of the present invention.

### DETAILED DESCRIPTION OF THE PRESENT INVENTION

Vehicle foam assemblies and methods of use are disclosed herein for forming and/or re-forming a skin against and/or around at least one insert component for creating a vehicle trim. The vehicle trim may be used for a vehicle interior, such as on a vehicle substrate (e.g., for use on an instrument panel, a door chassis, etc.). The assemblies may be employed for creating trim for use in automobiles, planes, trains, trucks, buses, boats, helicopters, submersible vehicles, spacecraft, or the like. In particular, the present invention relates to vehicle foam assemblies and methods of creating vehicle trim employing a foam tool. A skin is placed into and/or onto the foam tool, and against and/or around at least one insert component during the forming and/or re-forming processes. The foam assemblies employ a compact tooling design that reduces the costs associated with traditional skin tools and complex processes for vehicle trim manufacture, and reduce and/or eliminate gaps between a skin and one or more insert components.

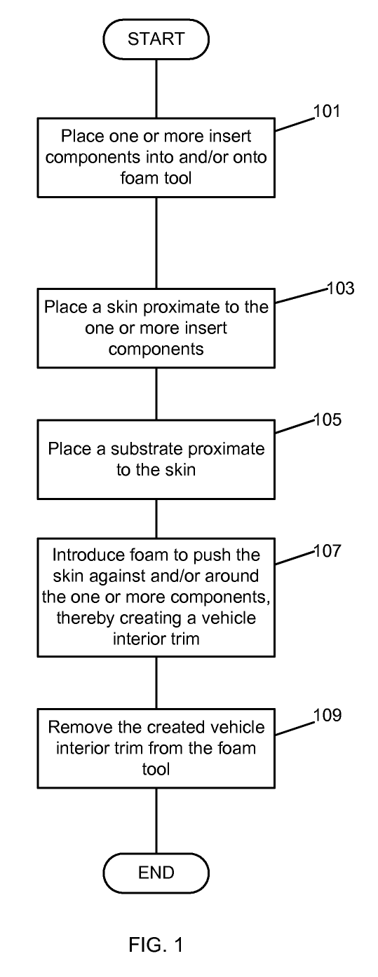

FIG. 1 is a flow diagram of a method of creating a vehicle trim in accordance with at least one aspect of the present invention. The method includes placing one or more insert components into a foam tool; laying a skin proximate to the one or more insert components; placing a substrate proximate to the skin; and introducing foam to push the skin against and/or around the one or more insert components. A skin that is already formed to have certain characteristics (e.g., has a shape, grain depth, texture, etc.) may be placed into the foam tool, and the skin may be re-formed against and/or around one or more inserts. According to one aspect of the invention, the term re-form means that the skin 5 may have been initially formed, such as negatively (e.g., via an in-mould graining process, etc.), positively, etc., prior to being introduced into the foam tool 1 for step 107. According to other aspects of the invention, the re-forming process need not require that the skin 5 be formed other than to make the skin 5 ready for the foaming process at step 107. For example, a re-formation may change or alter the characteristics of the skin from formation. The skin may be re-formed to accommodate the one or more inserts. For example, a skin that is substantially flat and has no inserts may be placed into the foam tool to be re-formed. When the skin is re-formed, the skin may have an altered shape, width, or the like as compared with the skin before re-formation. The altered characteristics may result from the skin re-forming around the one or more inserts, from any applied pressures and/or temperatures used during the process, a combination thereof, etc.

Although the methods disclosed herein may be employed with vehicle foam assemblies as described below, those skilled in the art will recognize that the methods for creating vehicle trim may be employed with alternative embodiments of foam assemblies.

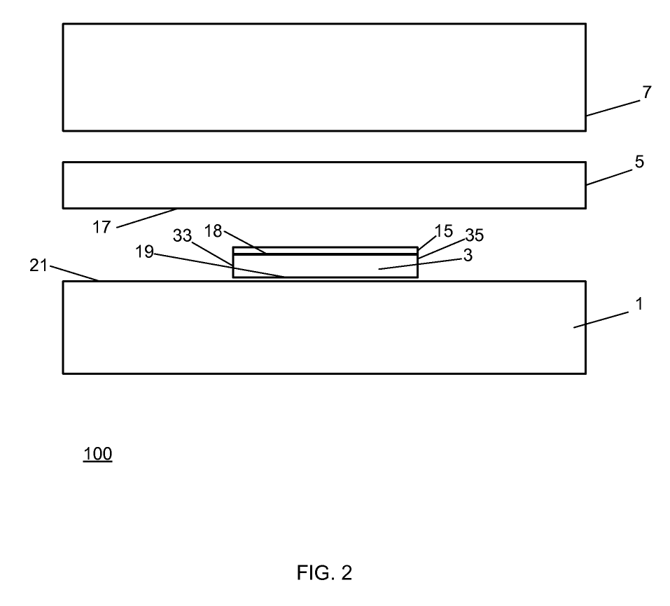

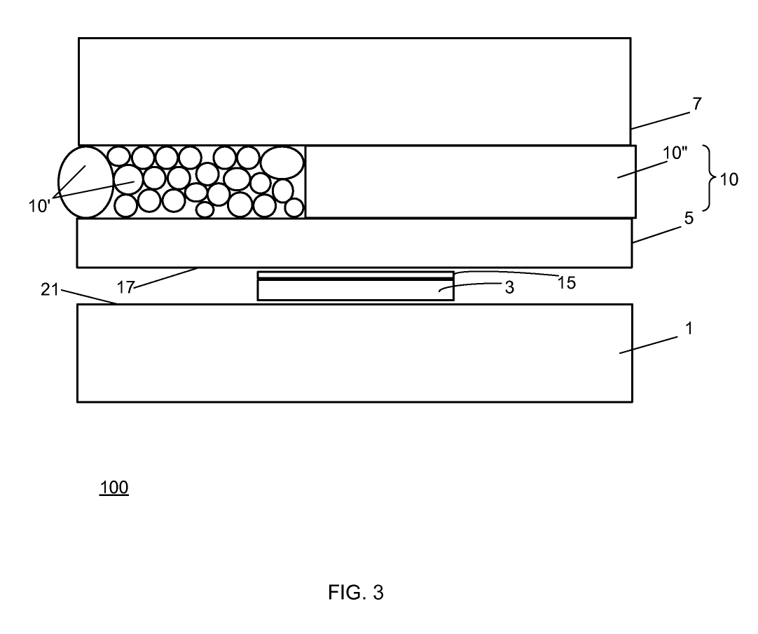

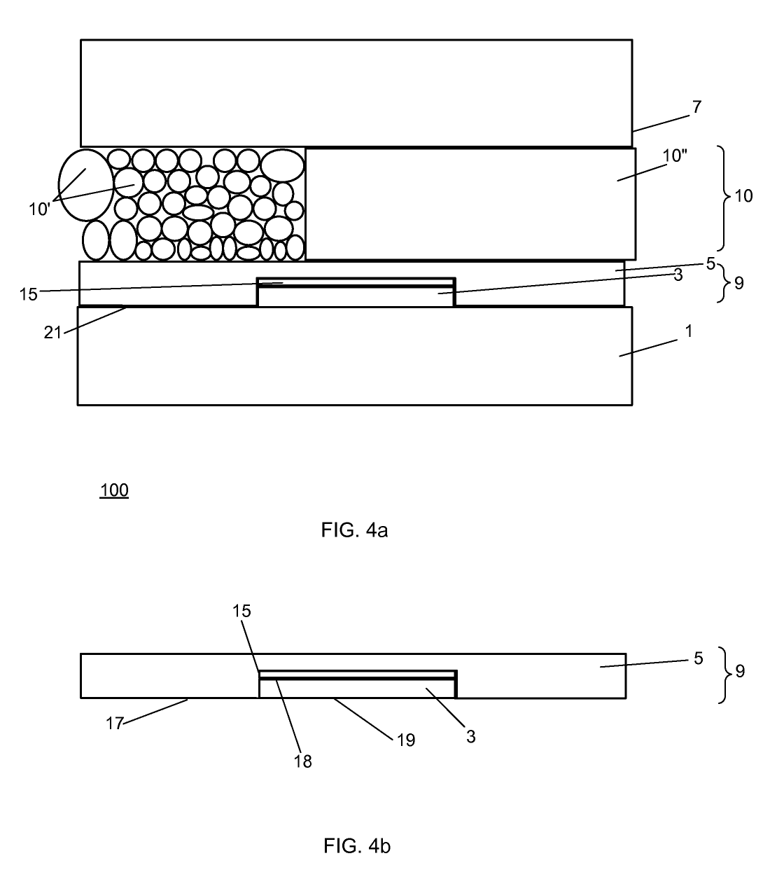

FIGS. 2-4a show a front view of a vehicle foam assembly 100 in accordance with at least another aspect of the present invention. The assembly 100 includes a foam tool 1, one or more insert components 3, a skin 5, a substrate 7, and foam 10 (as shown in FIGS. 3a-4a). Those skilled in the art will recognize that in the context of, for example, an automobile application, any type of insert component 3 or skin 5 may be used with assembly 100 to create a vehicle trim 9 (also referred to as “vehicle interior trim 9”), which is the combination of the insert component 3 and the skin 5 (as shown in FIG. 4a). The foam tool 1 may be formed from various materials, such as metal, plastic, polymer, rubber, etc. Those skilled in the art will recognize that any foam tool may be used to create the vehicle trim 9.

In accordance with at least one embodiment, and in accordance with step 101 of FIG. 1, the one or more insert components 3 are disposed on and/or in the foam tool 1. As best shown in FIG. 2, the one or more insert components 3 may include at least a first surface portion 18 proximate to the skin 5 and at least a second surface portion 19 proximate to the foam tool 1. Although not required to practice this embodiment of the invention, the foam tool 1 may employ a locating feature (discussed later herein) to hold the one or more insert components 3 in place during the re-forming process. The one or more insert components 3 may include an adhesive coating 15 for use in bonding with the skin 5. The adhesive coating 15 may bond the one or more insert components 3 to the skin 5 in response to various conditions, such as pressure, temperature, etc. For example, the adhesive coating 15 of the one or more insert components 3 may bond the one or more insert components 3 to the skin 5 when the foam 10 pushes the skin 5 against and/or around the one or more insert components 3. The adhesive coating 15 may be disposed on the at least first surface portion 18 of the one or more insert components 3 in communication with the skin 5 (as shown in FIGS. 2-4b) An OEM may desire to include various types of insert components into and/or onto a skin of the vehicle trim. For example, the one or more insert components 3 may be any of various trim components for use in a vehicle interior, such as a decorative insert, a foil, an insert molding film, etc. The one or more insert components 3 may include any foil known to those skilled in the art, such as thermo plastic olefin elastomer (also referred to as “TPO”), thermoplastic polyurethane (also referred to as “TPU”), poly vinyl chloride (also referred to as “PVC”), etc. Any size of foil may be employed, such as 0.8 mm-1.2 mm, 0.9 mm-1.0 mm, etc. The one or more insert components 3 may be formed from various materials, such as metal, plastic, polymer, rubber, etc.

Next, in accordance with step 103 of FIG. 1, the skin 5 is placed proximate to the one or more insert components 3. The skin 5 may be placed onto and/or into the foam tool 1, and may be disposed proximate to (e.g., on, over, around, etc.) the one or more insert components 3. Various arrangements of the skin 5 and the one or more insert components 3 may be employed such that the foam 10 re-forms the skin 5 against and/or around the one or more inserts 3. The skin 5 is formed before the re-forming process occurs. The skin 5 may be negatively formed (e.g., via an In-Mould Graining process “IMG”, etc.) or positively formed. The skin 5 may be formed such that the skin has particular characteristics, such as grain depth, texture, visual appearance, etc. The skin 5 may be formed from various materials, such as metal, plastic, polymer, rubber, etc.

Next, in accordance with step 105 of FIG. 1, a substrate 7 is placed proximate to (e.g., on, over, around, etc.) the skin 5. The substrate 7 may be disposed on and/or in the foam tool 1. Various arrangements of the skin 5 and the substrate 7 may be employed such that the foam 10 (as discussed below) pushes against the substrate 7 to force the skin 5 towards the one or more inserts 3. As aforementioned, the substrate 7 may be any structure known to those skilled in the art that provides support for allowing the foam 10 to push the skin 5 towards the one or more insert components 3. The substrate 7 may be the substrate of the vehicle on which the vehicle trim 9 may be disposed when the vehicle is constructed, such as an instrument panel, a door chassis, etc. Alternatively or additionally, the substrate 7 may be solely employed for the process of creating the vehicle trim 9. For example, the completed vehicle trim 9 may be removed from the substrate 7 used for the re-formation, and the vehicle trim 9 may be attached to a separate vehicle substrate later. The substrate 7 may be formed from various materials, such as metal, plastic, polymer, rubber, etc.

Next, in accordance with step 107 of FIG. 1, the foam 10 is introduced to re-form the skin 5 against and/or around the one or more insert components 3, thereby creating the vehicle trim 9. The foam 10 may push the skin 5 during re-formation. For example, the foam 10 may push the skin 5 away from the substrate 7 and towards the one or more insert components 3. The foam 10 may expand during the re-formation of the skin 5 to push the skin 5 away from the substrate 7. The foam 10 may be disposed between the substrate 7 and the skin 5 to push the skin 5 away from the substrate 7 and towards the one or more insert components 3 located within the foam tool 1. The foam 10 may be inserted into the assembly 100 in various arrangements such that the skin 5 re-forms against and/or around the one or more insert components 3. For example, the foam 10 may be injected under pressure between the substrate 7 and the skin 5, into the foam tool 1, etc. The consistency of the foam 10 may vary over a distance, such as between the substrate 7 and the skin 5, in the foam tool 1, etc. For example, the foam 10 may be granular (e.g., including air pockets separating portions 10′ of the foam 10) or substantially solid 10″ as best shown in FIGS. 3a-4a. Any foam known to those skilled in the art may be employed for the purposes of re-forming the skin 5 of the present invention, such TPO foam, TPU foam, PVC foam, etc. The foam 10 may provide various pressures and/or temperatures for activating the adhesive coating 15 (if employed) on the one or more insert components 3 when the foam 10 pushes the skin 5 away from substrate 7, such as during the foam expansion, injection under pressure, etc.

Alternatively or additionally, in accordance with step 109 of FIG. 1, the created vehicle trim 9 is removed from the foam tool 1 to be used in the construction of a vehicle component. The vehicle trim 9 may be removed from the assembly 100 before or after the re-formation of skin 5 occurs. The vehicle trim 9 may be used as a vehicle interior component. As best seen in FIG. 4b, the vehicle trim 9 may be a combination of the skin 5 and the one or more insert components 3. The vehicle trim 9 may be employed in and/or on any vehicle known to those skilled in the art. The vehicle trim 9 may be disposed on a substrate 7, such as a vehicle substrate, or alternatively on a substrate employed solely for the creation of the vehicle trim 9 (after which the substrate is removed from the trim 9 so that the trim 9 may be used in construction of a vehicle), etc.

As best seen in FIG. 4b, the one or more insert components 3 are arranged in a flush arrangement. A flush arrangement occurs when a surface (e.g., surface 19) of the one or more components 3 is located within the tool 1, such that when foam 10 pushes (e.g., during injection, expansion, etc.) the skin 5 away from the substrate 7 and around the one or more insert components 3, a surface 19 of the one or more insert components 3 is substantially aligned (e.g., co-planar) with the surface 17 of the skin 5. The foam tool 1 of vehicle foam assembly 100 may employ a flat surface (e.g., surface 21 as shown in FIGS. 2-4a) to establish the proper orientation of surface 19 of the one or more components 3 and the surface 17 of the skin 5 for the flush arrangement. Although not required for a flush arrangement, the foam tool 1 may employ a locating feature (discussed later herein) to hold the one or more insert components 3 in a flush arrangement during the re-forming process.

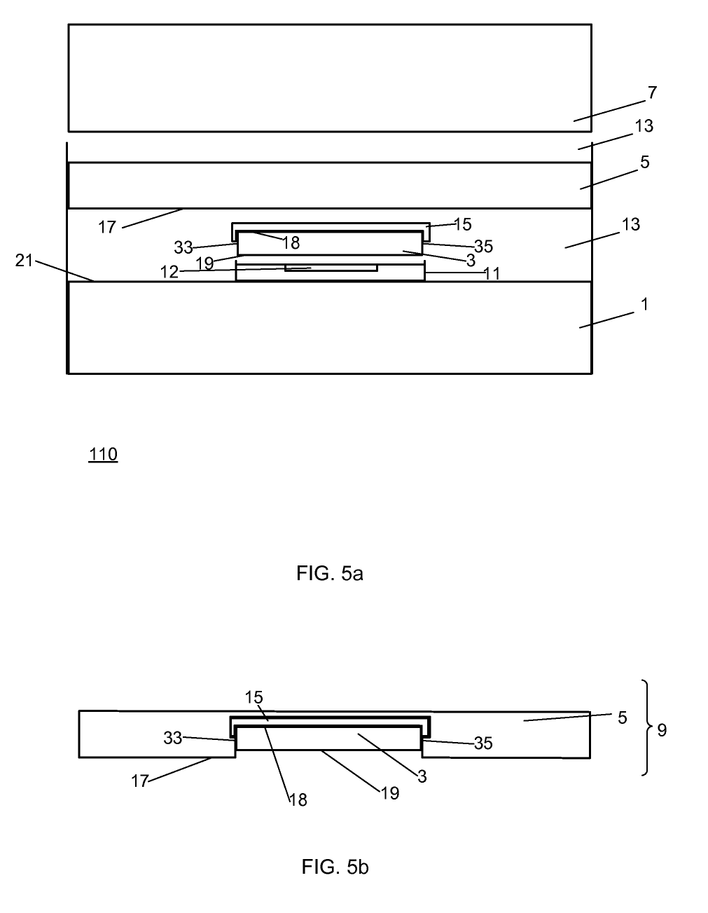

With reference to FIG. 5a, an alternative embodiment of a vehicle foam assembly 110 is illustrated. The foam assembly 110 is designed to create a subflush arrangement of the one or more insert components 3 within the tool 1. As best shown in FIG. 5b, a subflush arrangement occurs when the one or more insert components 3 are located within the tool 1 such that after the re-form step, the surface 19 of the component 3 is in a depressed position (e.g., below or lower than) with respect to the surface 17 of the skin 5. The foam tool 1 may include a cavity 13 (as shown in FIG. 5a) in which at least one of the one or more insert components 3, the skin 5, and the substrate 7 may be disposed. The cavity 13 may assist the insertion of the foam 10 by directing the foam 10 towards the skin 5. The cavity 13 may reduce the amount of foam 10 needed because the cavity 13 may prevent the foam 10 from escaping (e.g., expanding beyond, being injected out of, etc.) the tool 1 during step 107. To achieve the subflush arrangement, the foam tool 1 of vehicle foam assembly 110 may include a locating feature 11 and/or a vacuum 12 within the cavity 13 of foam tool 1. For the subflush arrangement, a top surface of the locating feature 11 and/or the vacuum 12 are raised above surface 21 of the tool 1. The one or more insert components 3 may be placed on and/or in the raised locating feature 11 or may be held in place by the vacuum 12 within the cavity 13. When foam 10 is inserted into the assembly 110, the foam 10 pushes the skin 5 away from the substrate 7 and towards the one or more insert components 3 disposed in and/or on the raised locating feature 11, such that the skin is re-formed against and/or around the one or more insert components 3 and the raised locating feature 11. As such, the one or more insert components 3 are located in a depressed position (e.g., below, lower, etc.) with respect to a surface 17 of the skin 5 (as shown in FIG. 5b).

As shown in FIG. 5a-5b, the one or more insert components 3 may include an adhesive coating 15 for use in bonding with the skin 5. The adhesive coating 15 may bond the one or more insert components 3 to the skin 5 in response to various conditions, such as pressure, temperature, etc. For example, the adhesive coating 15 of the one or more insert components 3 may bond the one or more insert components 3 to the skin 5 when the foam 10 pushes (e.g., from expansion, injection under pressure, etc.) the skin 5 against and/or around the one or more insert components 3. The adhesive coating 15 may be disposed on the at least first surface portion 18 of the one or more insert components 3 in communication with the skin 5. Alternatively or additionally, the adhesive coating 15 may be disposed on one or more surface portions, such as surface portion 18, side surface portion 33, side surface portion 35, etc., of the one or more insert components 3 (as shown in FIGS. 5a and 5b). The adhesive coating 15 may be disposed substantially around the one or more insert components 3 (as shown in FIGS. 5a and 5b).

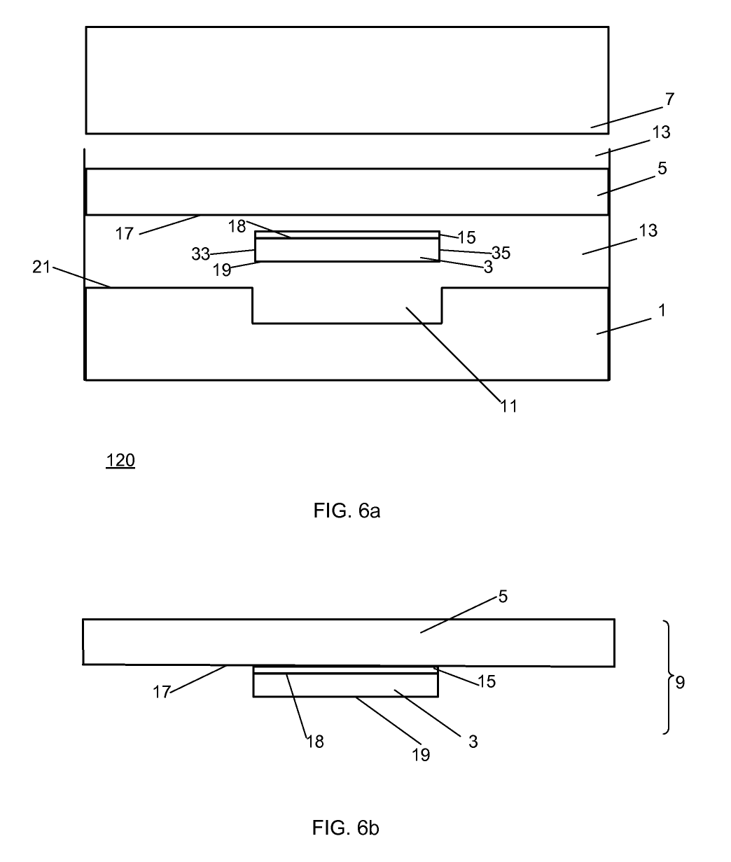

Reference is now made to FIG. 6a, which illustrates an alternative embodiment of a vehicle foam assembly 120. The foam assembly 120 is designed to create a proud arrangement of the one or more insert components 3 within the tool 1. A proud arrangement occurs when the one or more insert components 3 are located in a depressed position (e.g., into a depression, into a recess, into a groove, below or lower than the surface 21 of the foam tool 1, etc.) within and/or on the foam tool 1. Thus, after the re-form step, at least a portion of the one or more insert components 3 (such as the adhesive coating 15, the surface 19, etc.) extends beyond a surface 17 of the skin 5 as shown in FIG. 6b. The foam tool 1 may include a cavity 13 (as shown in FIG. 6a) in which at least one of the one or more insert components 3, the skin 5, and the substrate 7 may be disposed. To achieve the proud arrangement, the foam tool 1 of vehicle foam assembly 120 may include a locating feature 11 having a depression, an aperture, a groove, a recess, etc., in communication with a surface 21 of the foam tool 1, or may employ a vacuum 12 within the cavity 13. The one or more insert components 3 may be placed in the depression of the locating feature 11. For example, when foam 10 pushes (e.g., from expansion, injection under pressure, etc.) the skin 5 away from the substrate 7 and towards the one or more insert components 3 in assembly 120, the skin is re-formed proximate to (e.g., substantially on top of, over, etc.) the one or more insert components 3. As such, a surface 19 of the one or more insert components 3 extends outward beyond and away from the surface 17 of the skin 5 (as shown in FIG. 6b).

As shown in FIGS. 6a-6b, the one or more insert components 3 may include an adhesive coating 15 for use in bonding with the skin 5. The adhesive coating 15 may bond the one or more insert components 3 to the skin 5 in response to various conditions, such as pressure, temperature, etc. For example, the adhesive coating 15 of the one or more insert components 3 may bond the one or more insert components 3 to the skin 5 when the foam 10 pushes the skin 5 against and/or around the one or more insert components 3. The adhesive coating 15 may be disposed on the at least first surface portion 18 of the one or more insert components 3 in communication with the skin 5 (as shown in FIGS. 6a-6b). When the one or more insert components 3 and/or the adhesive coating 15 are located in the locating feature 11 below or lower than the surface 21 of the foam tool 1, the foam 10 may push (e.g., from expansion, injection under pressure, etc.) the skin 5 into the depression of the locating feature 11 during the re-forming process.

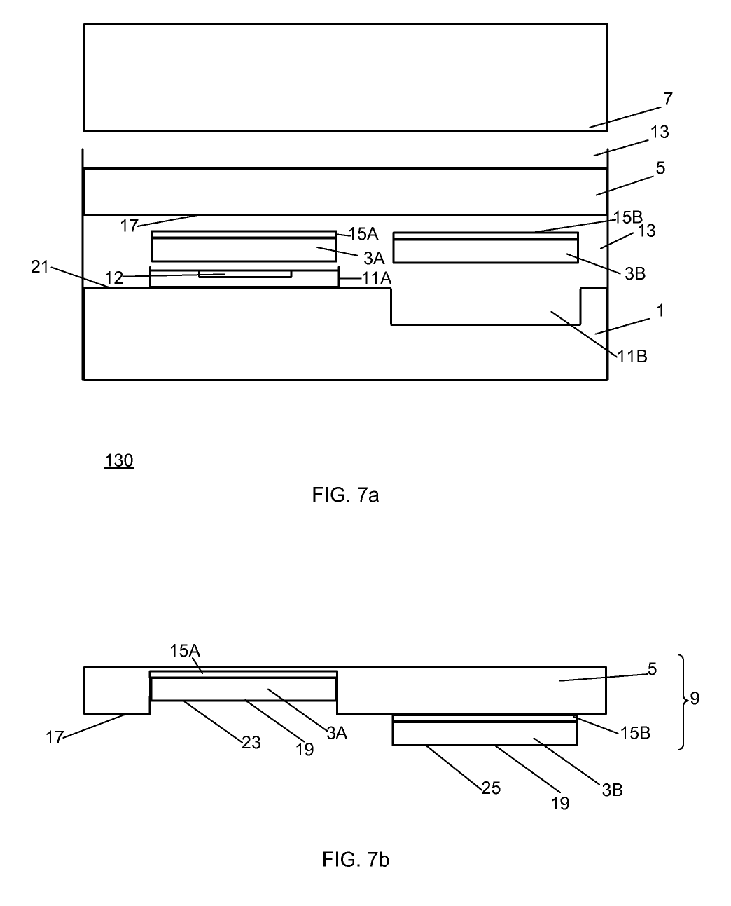

In accordance with at least an alternative embodiment of a foam assembly 130 as shown in FIG. 7a, the foam tool 1 may include more than one locating feature 11A, 11B and/or more than one vacuum 12 within cavity 13 to hold a plurality of insert components 3 in position for the creation of the vehicle trim 9. The vacuum 12 may be disposed on and/or in the locating feature 11A of the foam tool 1. Although not required to practice this embodiment of the invention, when an assembly, such as assemblies 110, 120, 130, etc., employs a cavity 13, the vacuum 12 may be created by closing the cavity 13 and removing the air within the closed cavity 13 of the foam tool 1. Employing more than one locating feature 11A, 11B may result in creation of one or more insert components 3 being located at various elevations with respect to each other, such as one or more layer levels 23, 25 (as shown in FIG. 7b) As shown in FIG. 7b, the skin 5 accommodates more than one insert component 3, with one insert component 3A located at layer level 23 and another component 3B located at layer level 25. The insert components 3A, 3B may employ adhesive coatings 15A, 15B (as shown in FIGS. 7a and 7b).

Alternatively, in accordance with another embodiment of the present invention, a skin (as schematically shown via skin 5 as aforementioned) that is not already formed to have certain characteristics (e.g., has a shape, grain depth, texture, etc.) may be placed into a foam tool, such as tool 1, and the skin may be formed against and/or around one or more inserts 3 placed into the foam tool 1 in accordance with steps 101-103 as aforementioned. In step 105, a substrate 7 is placed proximate (e.g., adjacent to, on top of, etc.) to the skin 5. According to one aspect of the invention, the term form means that the skin 5 may not have been initially formed, such as negatively (e.g., via an in-mould graining process, etc.), positively, etc., prior to being introduced into the foam tool 1 for step 107. The foaming of step 107 may form the skin 5. Alternatively or additionally, the foaming of step 107 may be combined with an additional formation process to form the skin 5. For example, the introduction of the foam 10 may push and form the skin 5 while the skin 5 is subject to a negative (e.g., in-mould-graining process, etc.) or positive formation process. According to other aspects of the invention, the forming process may only require that the skin 5 is ready to be formed during the foaming process at step 107. For example, a formation may create or establish the characteristics of the skin 5. The skin 5 may be formed to accommodate the one or more inserts 3. For example, a skin 5 that is substantially flat and has no inserts may be placed into the foam tool 1 to be formed. When the skin 5 is formed, the skin 5 may have a shape, width, or the like. The characteristics may result from the skin 5 forming around the one or more inserts 3, from any applied pressures and/or temperatures used during the process, a combination thereof, etc. Alternatively or additionally, the skin 5 may be formed only proximate to (e.g., against, around, on top of, etc.) the one or more inserts 3, and the remainder of the skin 5 may not be formed. Once the skin 5 has formed around and/or against the one or more insert components 3, the resulting vehicle interior trim 9 may be removed from the foam tool 1.

Although the forming methods disclosed herein may be employed with vehicle foam assemblies as described above and as shown in FIGS. 1-7a, those skilled in the art will recognize that the methods for creating vehicle trim may be employed with alternative embodiments of foam assemblies.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of creating vehicle interior trim, comprising:
placing one or more insert components onto and/or into a foam tool;
laying a skin proximate to the one or more insert components;
placing a substrate proximate to the skin; and
introducing foam to re-form the skin against and/or around the one or more insert components.

2. The method according to claim 1, further comprising:
inserting the foam between the substrate and the skin to push the skin away from the substrate and towards the one or more insert components located within the foam tool.

3. The method according to claim 2, wherein the insertion comprises at least one of: injecting the foam under pressure; and allowing the foam to expand to push the skin away from the substrate.

4. The method according to claim 3, wherein the expansion of the foam creates at least one of: pressure and temperature.

5. The method according to claim 2, further comprising:
adhesively coating a surface of the one or more insert components such that the one or more insert components bond to the skin when the foam pushes the skin against and/or around the one or more insert components.

6. The method according to claim 5, wherein the adhesive coating is placed on at least one of:
a surface portion of the surface of the one or more insert components proximate to the skin;
a surface portion of the surface of the one or more insert components proximate to the foam tool;
one or more side surface portions of the one or more insert components; and
the surface of the one or more insert components such that the adhesive coating is substantially around the surface.

7. The method according to claim 5, further comprising:
activating the adhesive coating of the one or more insert components to bond the one or more insert components to the skin with at least one of: pressure and temperature.

8. The method according to claim 1, further comprising at least one of: negatively forming the skin before re-formation; and positively forming the skin before re-formation.

9. The method according to claim 8, wherein the negative formation is an In-Mould Graining process.

10. The method according to claim 1, further comprising: arranging the one or more insert components on and/or in the re-formed skin in at least one of: a subflush arrangement, a flush arrangement, and a proud arrangement.

11. The method according to claim 10, further comprising holding the one or more insert components in position with at least one of: a locating feature; and a vacuum.

12. The method according to claim 11, further comprising at least one of:
employing a locating feature, raised from a surface of the foam tool, and/or the vacuum, disposed on the foam tool, to allow the skin to re-form against and/or around the one or more insert components, such that the one or more insert components are depressed below a surface of the skin, thereby creating the subflush arrangement;
employing a locating feature having a recess in communication with a surface of the foam tool and/or the vacuum in communication with a surface of the foam tool on which the one or more insert components are disposed, to allow the skin to re-form against and/or around the one or more insert components, such that a surface portion of the one or more insert components extends beyond a surface of the skin, thereby creating the proud arrangement; and
employing a locating feature and/or the vacuum in communication with a surface of the foam tool on which the one or more insert components are disposed, to allow the skin to re-form against and/or around the one or more insert components, such that a surface portion of the one or more insert components is substantially aligned with a surface of the skin, thereby creating the flush arrangement.

13. The method according to claim 1, further comprising creating one or more layer levels by placing the one or more insert components on and/or in the skin at various depths, wherein the foam tool allows the re-formation of the skin against and/or around the one or more insert components at the various depths.

14. The method according to claim 13, further comprising employing one or more locating features for creating the one or more layer levels.

15. The method according to claim 1, wherein the foam tool includes a cavity for disposing at least one of: the skin, the one or more insert components, and the substrate.

16. A method of creating vehicle interior trim, comprising:
placing one or more insert components onto and/or into a foam tool;
laying a skin proximate to the one or more insert components;
placing a substrate proximate to the skin; and
introducing foam to form the skin against and/or around the one or more insert components.

17. The method according to claim 16, further comprising:
inserting the foam between the substrate and the skin to push the skin away from the substrate and towards the one or more insert components located within the foam tool.

18. The method according to claim 17, wherein the insertion comprises at least one of: injecting the foam under pressure; and allowing the foam to expand to push the skin away from the substrate.

19. The method according to claim 18, wherein the expansion of the foam creates at least one of: pressure and temperature.

20. The method according to claim 16, further comprising at least one of: negatively forming the skin during formation; and positively forming the skin during formation.

21. The method according to claim 20, wherein the negative formation is an In-Mould Graining process.

22. The method according to claim 16, further comprising: arranging the one or more insert components on and/or in the formed skin in at least one of: a subflush arrangement, a flush arrangement, and a proud arrangement.

23. The method according to claim 22, further comprising holding the one or more insert components in position with at least one of: a locating feature; and a vacuum.

24. The method according to claim 23, further comprising at least one of:
employing a locating feature, raised from a surface of the foam tool, and/or the vacuum, disposed on the foam tool, to allow the skin to form against and/or around the one or more insert components, such that the one or more insert components are depressed below a surface of the skin, thereby creating the subflush arrangement;
employing a locating feature having a recess in communication with a surface of the foam tool and/or the vacuum in communication with a surface of the foam tool on which the one or more insert components are disposed, to allow the skin to form against and/or around the one or more insert components, such that a surface portion of the one or more insert components extends beyond a surface of the skin, thereby creating the proud arrangement; and
employing a locating feature and/or the vacuum in communication with a surface of the foam tool on which the one or more insert components are disposed, to allow the skin to form against and/or around the one or more insert components, such that a surface portion of the one or more insert components is substantially aligned with a surface of the skin, thereby creating the flush arrangement.

25. The method according to claim 16, further comprising creating one or more layer levels by placing the one or more insert components on and/or in the skin at various depths, wherein the foam tool allows the formation of the skin against and/or around the one or more insert components at the various depths.
